(19) United States
(12) Patent Application Publication
(10) Pub. No.: US 2002/0079369 A1
(43) Pub. Date: Jun. 27, 2002

(54) Bill-receiving device having function of counterfeit bill and counterfeit card-preventing

(76) Inventor: Jong-Jiing Shiau, Taichung (TW)

Correspondence Address: BACON & THOMAS, 625 Slaters Lane - 4th Floor, Alexandria, VA, 22314, US

(21) Appl. No.: 09/741,064

(22) Filed: Dec. 21, 2000

(51) Int. Cl. G06K 7/00

(52) U.S. Cl. 235/438

(57) ABSTRACT

A bill-receiving device having an upper cover, a print checking region and an ultraviolet ray checking region are installed thereon. Other than receiving bill or being inserted by a credit card, the bill-receiving device has further the function of counterfeit bill and counterfeit card-preventing. Therefore, the loss in business can be reduced.

### BACKGROUND OF THE INVENTION

The present invention relates to a bill-receiving device. Other than receiving bill or being inserted by a credit card, the bill-receiving device has further the function of counterfeit bill and counterfeit card-preventing. Therefore, loss in business can be reduced.

The bill-receiving device of first type is developed in 1952 by NCR. It is operated through mechanic button. The display of the amount of money is displayed through rotary wheels. It is a machine only for receiving bill. A second type bill-receiving device is an electronic machine. The mathematical operation is added therein and the display is an LED display. A third type bill-receiving device is a microelectronic machine. It has the function of printing invoice and receipt. Moreover, some functions, such as actuation of encrypting code, calculation of tax, and discount of sailing, can be achieved by an inner chip. Afterwards, a fourth type is developed, in which a laser code reader is attached for being connected to a computer so that it has the function of stock control, financial management, etc.

The current used bill-receiving devices are mostly third and fourth bill-receiving devices. However, they have the function of accounting, bill-receiving, or stock control. This only satisfies the end user. No bill-receiving device has the function of counterfeit bill and counterfeit card preventing, which is an advance use of a bill-receiving device. That is, if a bill-receiving device has the function of counterfeit bill and counterfeit card-preventing, the operator may control the risk in advance. Therefore, the present invention is developed basis on the advance use so as to award a bill-receiving device with functions of counterfeit bill and counterfeit card preventing.

### SUMMARY OF THE INVENTION

Accordingly, the primary object of the present invention is to provide a bill-receiving device having an upper cover. Other than receiving bill or being inserted by a credit card, the bill-receiving device has further the function of counterfeit bill and counterfeit card-preventing. Therefore, loss in business can be reduced. Thereby, the operator checks the bill in secret so that the customer will not feel uneasy.

To achieve the object, the present invention provides a bill-receiving device for counterfeit bill and counterfeit card-preventing, which has an upper cover. A print checking region and an ultraviolet ray checking region are installed thereon. In the print checking region, the upper cover is designed with a transparent plate. A window hole is formed on the upper cover. The transparent plate is placed thereon. Two nose portions having springs are installed at the edge of the window hole. A microswitch is installed at a proper place of the window hole for actuating the white light lamp. In the ultraviolet ray checking region, a mask is installed on the upper cover; and an ultraviolet lamp is installed in the mask.

The various objects and advantages of the present invention will be more readily understood from the following detailed description when read in conjunction with the appended drawing.

### BRIEF DESCRIPTION OF THE DRAWINGS

FIG. 1 is an exploded perspective view of the first embodiment in the present invention.

FIG. 2 is an assembled perspective view of the first embodiment in the present invention.

FIG. 3 is a cross sectional view along line 3-3 of FIG. 2.

FIG. 4 is an exploded perspective view of the second embodiment in the present invention.

FIG. 5 is an assembled perspective view of the second embodiment in the present invention.

FIG. 6 is a cross sectional view along line 6-6 of FIG. 4.

### DETAILED DESCRIPTION OF THE PREFERRED EMBODIMENTS

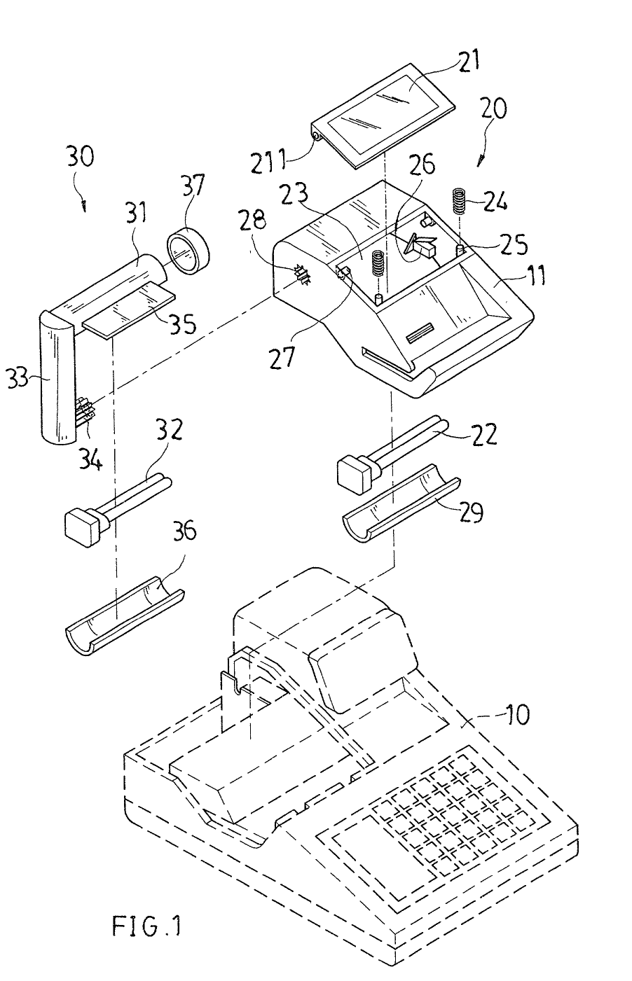

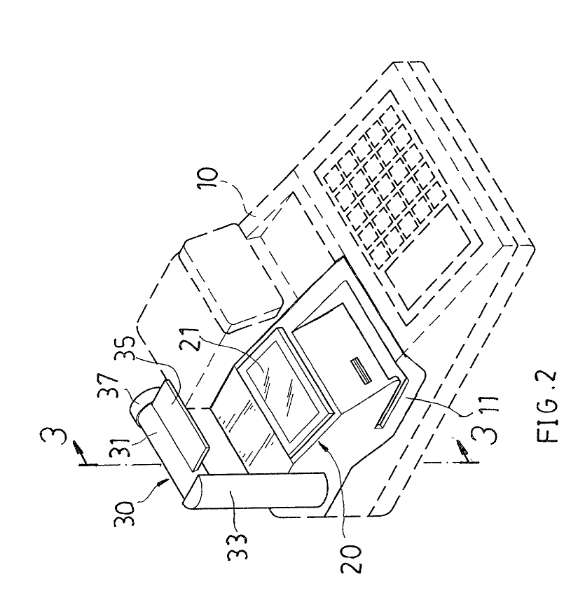

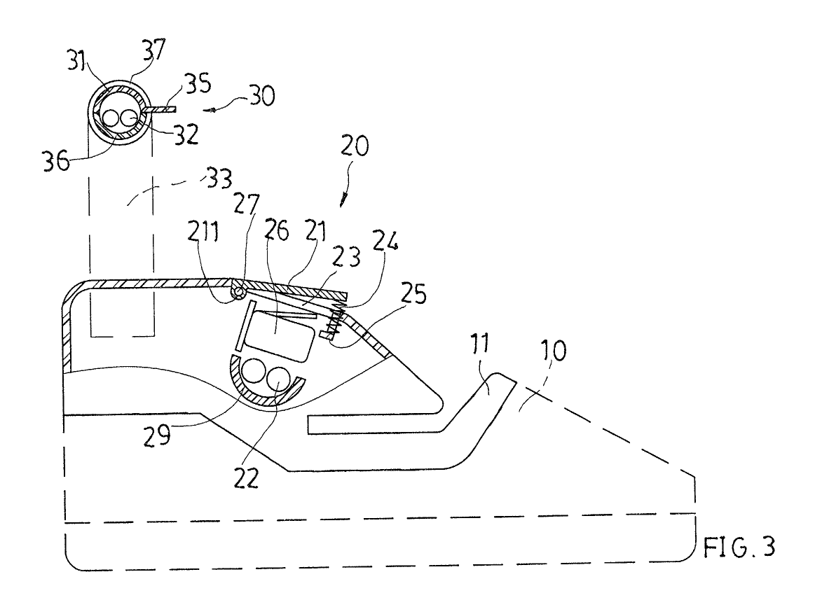

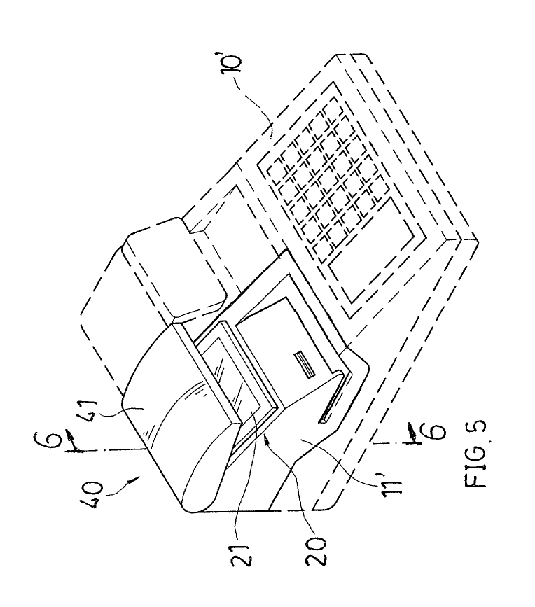

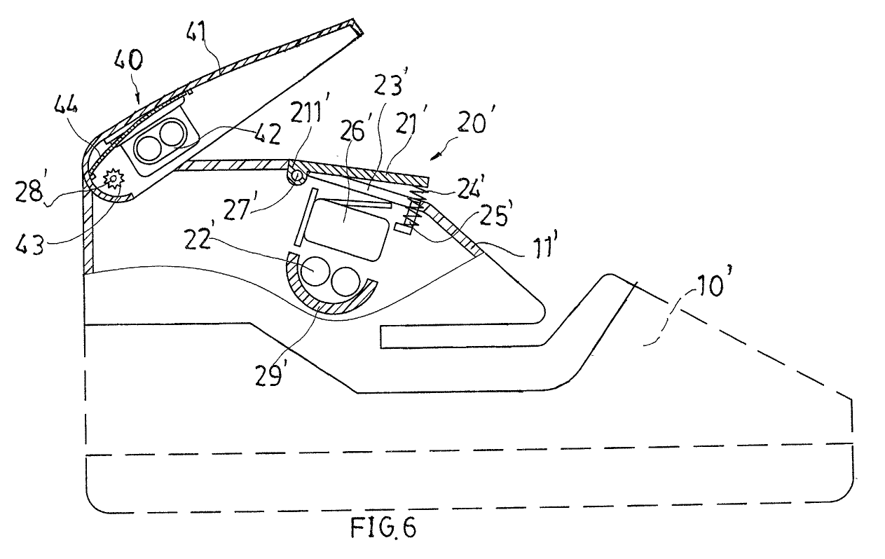

Referring to FIGS. 1 to 6, the bill-receiving device of the present invention will be illustrated in the following, thereby; those skilled in the art can fully understand the present invention.

The bill-receiving device 10 of the present invention mainly includes an upper cover 11; a print checking region 20 and a ultraviolet ray checking region 30 are installed thereon.

For the print checking region 20, the upper cover 11 is designed with a transparent plate 21. A white light lamp 22 (such as a fluorescent light, an LED light, or a bulb) is installed below the transparent plate 21. A light source emits the transparent plate 21 for checking the print of the bill. A window hole 23 is formed on the upper cover 11. The transparent plate 21 is placed thereon. The light emits to the transparent plate 21 through the window hole 23. Two nose portions 25 having springs 24 are installed at the edge of the window hole 23. Thereby, a slight length for the transparent plate 21 and the window hole 23 is formed. A microswitch 26 is installed at a proper place of the window hole 23 for actuating the white light lamp 22. Two respective pits 27 are formed at an edge of the window hole 23. The transparent plate 21 is formed with ears 211 at positions with respect to the pits 27 of the window hole 23. Thereby, the transparent plate 21 is connected to the window hole 23 by connecting one end to one opening. Furthermore, two sides of the upper cover 11 are installed with stud holes 28. A reflecting mask 29 is installed below the white light lamp 22. Thereby, it has the effect of focusing the white light and heat isolation.

For the ultraviolet ray checking region 30, a mask 31 is installed on the upper cover 11. An ultraviolet lamp 32 is installed in the mask 31. The ultraviolet lamp 32 is extended from one arm 33. A shaft 34 is protruded at the inner side of the arm 33. By the engagement of the shaft 34 with the stud hole 28 of the print checking region 20, the arm 33 can be connected to one side of the upper cover 11. Therefore, the ultraviolet lamp 32 is indirectly installed on the upper cover 11. The mask 31 is further installed with a shield 35 for shielding part of the light from the ultraviolet lamp 32 so as not to radiate directly to the operator of the bill-receiving device. A transparent mask 36 is installed below the mask 31. A lateral cover 37 serves to cover the mask 31 and the transparent mask 36 for preventing bugs to fly thereinto.

By the aforesaid structure, when an operator receives a bill, the bill can be placed directly on the transparent plate 21 of the print checking region 20 and is pressed slightly to touch the microswitch 26 so as to actuate the white light lamp 22. Then light may incident into the bill for checking the bill. If the bill is a counterfeit bill, the bill will not be received, the operator may inform a police. If the bill is a real one, then, it can be received. Therefore, the operator is needless to check the bill by viewing in front of a customer so that the customer will fell uneasy.

When the operator receive a credit card, it can be placed to the mask 31 of the ultraviolet ray checking region 30. By the ultraviolet lamp 32 of the mask 31 to radiate to the credit card, the fluorescent mark is displayed for being adjusted. Similarly, the operator is needless to check the bill by viewing in front of a customer so that the customer will fell uneasy. If the credit card is a counterfeit one, it will not be received, and the operator may inform a police.

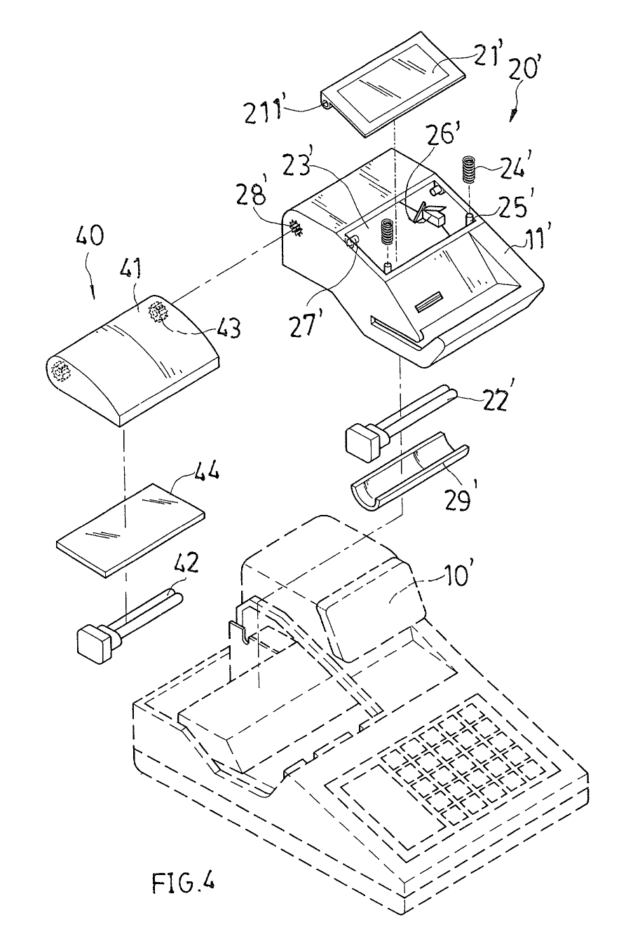

Furthermore, another embodiment of the present invention will be described in the following with reference to FIGS. 4, 5, and 6. The bill-receiving device 10 of the present invention mainly includes an upper cover 11′, a print checking region 20′ and a ultraviolet ray checking region 30′ are installed thereon.

For the print checking region 20′, the upper cover 11′ is designed with a transparent plate 21′. A white light lamp 22′ (such as a fluorescent light, an LED light, or a bulb) is installed below the transparent plate 21′. A light source emits the transparent plate 21′ for checking the print of the bill. A window hole 23′ is formed on the upper cover 11′. The transparent plate 21′ is placed thereon. The light emits to the transparent plate 21′ through the window hole 23′. Two nose portions 25′ having springs 24′ are installed at the edge of the window hole 23′. Thereby, a slight length for the transparent plate 21′ and the window hole 23′ is formed. A microswitch 26′ is installed at a proper place of the window hole 23′ for actuating the white light lamp 22′. Two respective pits 27′ are formed at an edge of the window hole 23′. The transparent plate 21′ is formed with ears 211′ at positions with respect to the pits 27′ of the window hole 23′. Thereby, the transparent plate 21′ is connected to the window hole 23′ by connecting one end to one opening. Furthermore, two sides of the upper cover 11′ are installed with stud holes 28′. A reflecting mask 29′ is installed below the white light lamp 22′. Thereby, it has the effect of focusing the white light and heat isolation.

For the ultraviolet ray checking region 40, a mask 41 is installed on the upper cover 11′. An ultraviolet lamp 42 is installed in the mask 41. A shaft 43 is protruded at the inner side of the mask 41. By the engagement of the shaft 43 with the stud hole 28′ of the print checking region 20′, the mask 41 is engaged to the upper cover 11′. A reflector 44 is installed between the mask 41 and the ultraviolet lamp 42 for enhancing the strength of the ultraviolet lamp 42.

By the aforesaid structure, when an operator receives a bill, the bill can be placed directly on the transparent plates 21, 21′ of the print checking regions 20, 20′ and is pressed slightly to touch the microswitchs 26, 26′ and actuate the white light lamps 22, 22′. Then light may incident into the bill for checking the bill. If the bill is a counterfeit bill, the bill will not be received, and the operator may inform a police. If the bill is a real one, then, it can be received. Therefore, the operator is needless to check the bill by viewing in front of a customer so that the customer will fell uneasy.

When the operator receive a credit card, it can be placed to the masks 31, 41 of the ultraviolet ray checking region 30, 40. By the ultraviolet lamps 32, 42 of the masks 31, 41 to radiate the credit card, the fluorescent mark of a credit card is displayed for being adjusted. Similarly, the operator is needless to check the bill by viewing in front of a customer so that the customer will fell uneasy. If the credit card is a counterfeit one, it will not be received, the operator may inform a police.

In the present invention, the functions of counterfeit bill and counterfeit card preventing are integrated into a bill-receiving device, this design has the advantages of:

1. The checking of counterfeit bill and counterfeit card is executed with a high efficiency, thus the whole process does not be interfered.

2. The function of counterfeit bill and counterfeit card-preventing is integrated into a bill-receiving device, the customers will not feel uneasy.

3. The checking of counterfeit bill and counterfeit card is executed with a high efficiency, thus the loss in business is low. Therefore, the present invention is an effective manage device.

4. In the present invention, the function of counterfeit bill and counterfeit card-preventing is integrated into a bill-receiving device, the cost is low.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bill-receiving device for counterfeit bill and counterfeit card-preventing having an upper cover, a print checking region and a ultraviolet ray checking region being installed thereon, wherein in the print checking region, the upper cover is designed with a transparent plate, a white light lamp is installed below the transparent plate, a window hole is formed on the upper cover; the transparent plate is placed thereon; two nose portions having springs are installed at an edge of the window hole; a microswitch is installed at a proper place of the window hole for actuating the white light lamp; in the ultraviolet ray checking region, a mask is installed on the upper cover; and an ultraviolet lamp is installed in the mask.

2. The bill-receiving device for counterfeit bill and counterfeit card-preventing as claimed in claim 1, wherein a reflecting mask is installed below the white light lamp.

3. The bill-receiving device for counterfeit bill and counterfeit card-preventing as claimed in claim 1, wherein a reflector is installed between the mask of the ultraviolet ray checking region and the ultraviolet lamp.

4. The bill-receiving device for counterfeit bill and counterfeit card-preventing as claimed in claim 1, wherein two sides of the upper cover are installed with stud holes, a plurality of shafts are installed in the mask; the stud holes are engaged with the shafts.

5. The bill-receiving device for counterfeit bill and counterfeit card-preventing as claimed in claim 1, wherein two sides of the upper cover are installed with stud holes, the mask of the ultraviolet ray checking region extends from one arm on the upper cover; shafts are protruded from an inner side of the arm; the stud holes are engaged with the shafts.

6. The bill-receiving device for counterfeit bill and counterfeit card-preventing as claimed in claim 2, wherein two sides of the upper cover are installed with stud holes, the mask of the ultraviolet ray checking region extends from one arm on the upper cover; shafts are protruded from an inner side of the arm; the stud holes are engaged with the shafts.

7. The bill-receiving device for counterfeit bill and counterfeit card-preventing as claimed in claim 5, wherein a rim is formed on the mask.

8. The bill-receiving device for counterfeit bill and counterfeit card-preventing as claimed in claim 6, wherein a rim is formed on the mask.

9. The bill-receiving device for counterfeit bill and counterfeit card-preventing as claimed in claim 5, wherein a transparent mask is installed below the mask; a lateral cover serves to cover the mask and the transparent mask.

10. The bill-receiving device for counterfeit bill and counterfeit card-preventing as claimed in claim 6, wherein a transparent mask is installed below the mask; a lateral cover serves to cover the mask and the transparent mask.
